(19) United States
(12) Patent Application Publication
(10) Pub. No.: US 2007/0148462 A1
(43) Pub. Date: Jun. 28, 2007

(54) ARTICLE HAVING DIAMOND-LIKE CARBON COMPOSITE FILM AND METHOD FOR MANUFACTURING THE SAME

(75) Inventors: Bor-Yuan Hsiao, Tu-Cheng (TW); Jhy-Chain Lin, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,602

(22) Filed: Aug. 29, 2006

(30) Foreign Application Priority Data
Dec. 22, 2005 (CN) 200510121035.1

(51) Int. Cl. B32B 9/00; B32B 15/00

(52) U.S. Cl. 428/408; 428/615

(57) ABSTRACT

An exemplary article has a body made of steel, an electroless nickel layer electroless-plated on the body, and a diamond-like carbon layer formed on the electroless nickel layer. An exemplary method for manufacturing the article includes the steps of: providing a body made of steel; electroless plating an electroless nickel layer on the body; and forming a diamond-like carbon layer on the electroless nickel layer. The article has some excellent properties such as wear resistance, corrosion resistance and magnetic properties.

### TECHNICAL FIELD

The present invention generally relates to articles with diamond-like carbon films, and more particularly relates to an article having a diamond-like carbon composite film with magnetic properties. The present invention also relates to a method for manufacturing the article.

### BACKGROUND

Diamond-like carbon is a mostly metastable amorphous material but can include a microcrystalline phase. Diamond-like carbon includes amorphous carbon (a-C) and hydrogenated amorphous carbon (a-C:H) with significant sp³ bonding. The sp³ bonding provides the diamond-like carbon film with valuable diamond-like properties such as mechanical hardness, low friction, optical transparency and chemical inertness. Therefore, the diamond-like carbon film is widely used in electrical appliances, optical elements, molds and cutting tools.

In order to enhance an adhesion between the diamond-like carbon film and a steel substrate, an intermediate layer is often sandwiched therebetween. The intermediate layer not only facilitates adhesion to the steel substrate, but also improves existing properties of the diamond-like carbon film whilst adding new ones. Thus the diamond-like carbon film can gain new applications due to the new properties. As the technology has evolved, it is desirable for metal products made of steel to have a film with wear resistance, corrosion resistance and other properties such as magnetic properties.

What is needed, therefore, is an article having a diamond-like carbon composite film with magnetic properties. What is also needed, therefore, is a method for manufacturing the article.

### SUMMARY

One embodiment provides an article having a body made of steel, an electroless nickel layer electroless-plated on the body, and a diamond-like carbon layer formed on the electroless nickel layer.

Another embodiment provides a method for manufacturing an article. The method includes steps of: providing a body made of steel; electroless plating an electroless nickel layer on the body; and forming a diamond-like carbon layer on the electroless nickel layer.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present method. Moreover, in the drawings, like reference numerals designate corresponding parts throughout the several views.

FIG. 1 is a schematic, cross-sectional view of an article according to a preferred embodiment;

FIG. 2 is a flow chart of a method for manufacturing an article according to another preferred embodiment; and

FIG. 3 is a schematic view of a sputtering apparatus for manufacturing the article of FIG. 1.

### DETAILED DESCRIPTION OF PREFERRED EMBODIMENTS

Embodiments will now be described in detail below and with reference to the drawings.

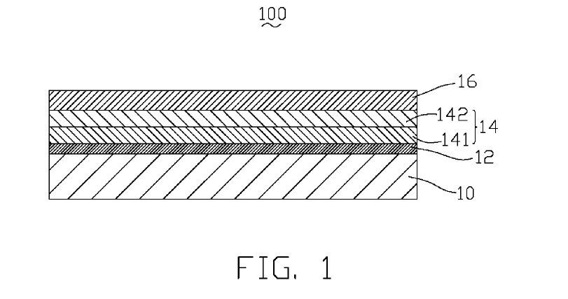

Referring to FIG. 1, an article 100 according to an exemplary embodiment is shown. The article 100 includes a body 10, an electroless nickel layer 12, a transition layer 14 and a diamond-like carbon layer 16.

The body 10 is made of steel. The electroless nickel layer 12 is formed on the body 10. Electroless nickel has some excellent properties. For example, electroless nickel has shown its ability to withstand the combination of corrosive chemicals and abrasion. For another example, electroless nickel has magnetic properties. Therefore, the electroless nickel layer 12 has excellent wear resistance, corrosion resistance and magnetic properties. The electroless nickel layer 12 can have a thickness in a range from 5 microns to 50 microns.

The diamond-like carbon layer 16 is an outermost layer and can be formed on the electroless nickel layer 12. The diamond-like carbon layer 16 serves as a wear resistant coating due to its high mechanical hardness, smoothness, low reactivity, wear resistance and corrosion resistance. A thickness of the diamond-like carbon layer 16 can be in a range from 5 nanometers to 2000 nanometers.

The transition layer 14 is an optional layer. The transition layer 14, if so formed, can enhance an adhesion between the electroless nickel layer 12 and the diamond-like carbon layer 16. The transition layer 14 can be a single-layer structure or a multilayer structure.

In the exemplary embodiment, the transition layer 14 is sandwiched between the electroless nickel layer 12 and the diamond-like carbon layer 16. The transition layer 14 includes a first transition layer 141 and a second transition layer 142. The first transition layer 141 is formed on the electroless nickel layer 12. The first transition layer 141 can be selected from a group consisting of chromium (Cr), titanium (Ti), and chromium titanium (CrTi). In the embodiment, the first transition layer 141 is a chromium film. A thickness of the first transition layer 141 can be in a range from 1 nanometer to 30 nanometers. The second transition layer 142 is formed on the first transition layer 141 and sandwiched between the first transition layer 141 and the diamond-like carbon layer 16. The second transition layer 142 can be selected from a group consisting of chromium nitride (CrN), titanium nitride (TiN) and chromium titanium nitride (CrTiN). In the illustrated embodiment, the second transition layer 142 is a chromium nitride film. A thickness of the second transition layer 142 can be in a range from 1 nanometer to 50 nanometers.

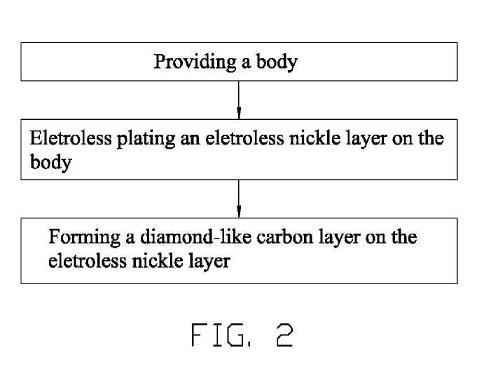

Referring to FIG. 2, a method for manufacturing the article 100 is shown. The method mainly includes the steps of:

providing a body 10 made of steel;
electroless plating an electroless nickel layer 12 on the body 10; and
forming a diamond-like carbon layer 16 on the electroless nickel layer 12.

The following embodiment is provided to describe the method for manufacturing the article 100 in detail.

The body 10 is made of steel, therefore ultrasonic cleaning is firstly performed for cleansing the surface of the body 10 before electroless plating the electroless nickel layer 12 onto the body 10. Contamination on the surface of the body 10 that is soluble or emulsifiable can usually be removed by means of ultrasonic cleaning in suitable solvents or detergent solutions. For example, cleansing the body 10 can be performed in an acetone-containing solution in an ultrasonic cleaner. Moreover, the smoother the surface of the body 10, the better the qualities of the electroless nickel deposits.

Then, the electroless plating process is performed in an electroless plating apparatus for depositing the electroless nickel layer 12 on the body 10. The electroless plating process is a plating process without an external current source. The electroless nickel is deposited on the surface of the body 10 by the autocatalytic reduction of nickel ions in acid baths. Electroless nickel has some advantages such as having excellent wear resistance and magnetic properties, and can be deposited to form a uniform coating regardless of substrate shape. The electroless nickel layer 12 formed on the body 10 can have a thickness in a range from 5 microns to 50 microns.

Preferably, the body 10 with the electroless nickel layer 12 thereon is cleaned with warm water to remove the residual chemical solution on the electroless nickel layer 12.

Alternatively, in order to gain the electroless nickel layer 12 with good qualities, a step of electroplating a nickel layer on the body 10 can be performed prior to electroless plating the electroless nickel layer 12 on the body 10. The electroplating solution can be a solution containing nickel chloride. The electroplating can be performed at a direct current voltage of about 2 volts. Electroplating of the nickel layer can last for a time period in a range from 30 seconds to 60 seconds.

After the step of cleaning, a step of heating the body 10 with the electroless nickel layer 12 thereon can optionally be performed to improve properties of the electroless nickel layer 12, such as hardness, corrosion resistance, wear resistance, ductility, fatigue properties, and magnetic properties. For example, the hardness of the electroless nickel layer 12 can be increased via heating. The step of heating the body 10 with the electroless nickel layer 12 thereon can be performed at a temperature in a range from 350 degrees Celsius to 450 degrees Celsius. A time period of heating can be about 1 hour. The step of heating the body 10 with the electroless nickel layer 12 thereon should be carried out in an inert atmosphere such as argon and/or nitrogen to minimize oxidation.

In the step of forming the diamond-like carbon layer 16, a step of forming the transition layer 14 on the electroless nickel layer 12 can be selectively performed. The transition layer 14 includes the first transition layer 141 and the second transition layer 142.

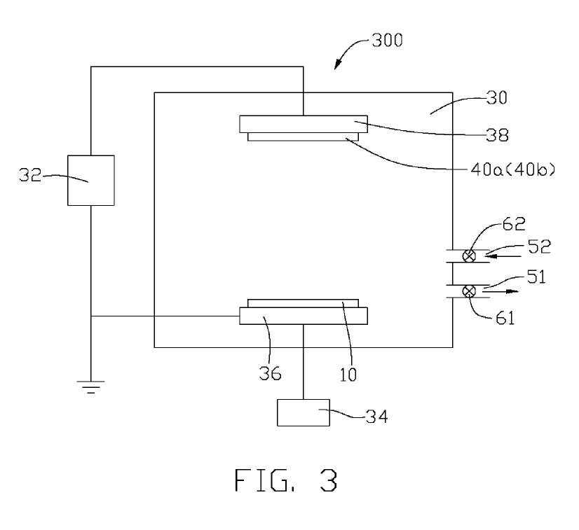

Referring to FIG. 3, a sputtering device 300 is shown. The sputtering device 300 includes a chamber 30, a power supply 32, a bias voltage power 34, a first electrode stage 36 and a second electrode stage 38 opposite to the first electrode stage 36. The body 10 is disposed on the first electrode stage 36, and a metal target 40a or 40b is disposed on the second electrode stage 38. The chamber 30 defines a gas exit 51 and a gas entrance 52 on the sidewall thereof. The gas exit 51 and the gas entrance 52 are respectively controlled by a gas exit control valve 61 and a gas entrance control valve 62 to adjust the sputtering gas flow rate. The power supply 32 is connected to the first electrode stage 36 and the second electrode stage 38. The power supply 32 can be a radio frequency power supply, an alternating current power supply or a direct current power supply. The bias voltage power supply 34 is connected to the first electrode stage 36 to provide the body 10 on the first work stage 36 with a negative bias voltage. The bias voltage power supply 32 can be an alternating current power supply or a direct current power supply.

At first, the first transition layer 141 is formed on the electroless nickel layer 12 in the sputtering device 300. A thickness of the first transition layer 141 deposited on the body 10 can be in a range from 1 nanometer to 30 nanometers. The metal target 40a is disposed on the second electrode stage 38. The metal target 40a can be selected from a group consisting of chromium (Cr), titanium (Ti) and chromium titanium (CrTi). An inert gas is introduced into the vacuum chamber 30 by controlling the gas exit control valve 61 and the gas entrance control valve 62. The inert gas can be selected from a group consisting of argon, krypton, xenon and radon. The flow rate of the inert gas can be in a range from 1 to 100 standard cubic centimeters per minute (sccm). In the exemplary embodiment, the inert gas introduced into the chamber 30 is argon. The argon plasma is generated by argon due to high electrical energy and is configured for bombarding the target 40a. Atoms in the target 40a are ejected into the gas phase due to bombardment of the argon plasma with energy in a range from 300 to 1000 watts. Atoms ejected from the target 40a are then deposited onto the body 10.

The sputtering process should be performed at a temperature in a range from 25 degrees Celsius to 150 degrees Celsius, at a bias voltage in a range from −50 volts to 200 volts, and at a pressure in a range from 1×10⁻⁵ pascals to 10×10⁻⁴ pascals. After a certain time period, the first transition layer 141 is formed on the electroless nickel layer 12.

The second transition layer 142 is then formed on the first transition layer 141. A thickness of the second transition layer 142 deposited can be in a range from 1 nanometer to 30 nanometers. The method of forming the second transition layer 142 is similar to the method of forming the first transition layer 141. However, some differences should be noted. A mixed gas consisting of an inert gas and nitrogen is introduced into the chamber 30. The inert gas can be selected from a group consisting of argon, krypton, xenon and radon. The flow rate of the mixed gas can be in a range from 1 to 100 standard cubic centimeters per minute (sccm). In the exemplary embodiment, the inert gas is the argon. A mixed plasma of argon plasma and nitrogen plasma generated by argon and nitrogen due to high electrical energy is reacted with atoms ejected from the target 40a to form a nitride and deposit on the body 10. The other control conditions of forming the second transition layer 142 are similar to the control conditions of forming the first transition layer 141.

After forming the transition layer 14, the diamond-like carbon layer 16 is formed on the transition layer 14 by sputtering a carbon target 40b in the sputtering device 300. If the transition layer 14 is not deposited, the diamond-like carbon layer 16 can be formed on the electroless nickel layer 12 directly. A thickness of the diamond-like carbon layer 16 deposited can be in a range from 5 nanometers to 2000 nanometers. The method of forming the diamond-like carbon layer 16 is similar to the method of forming the transition layer 14. However, some differences should be noted. A mixed gas consisting of an inert gas and a hydrogen-containing gas is introduced into the chamber 30. The inert gas can be selected from a group consisting of argon, krypton, xenon and radon. The hydrogen-containing gas can be selected from a group consisting of methane, ethane, hydrogen, and ethyne. The flow rate of the mixed gas can be in a range from 1 to 100 standard cubic centimeters per minute (sccm). In the exemplary embodiment, the inert gas is argon and the hydrogen-containing gas is hydrogen. A mixed plasma of argon plasma and hydrogen plasma generated by argon and hydrogen due to high electrical energy is reacted with carbon atoms ejected from the target 40b to deposit reactive products on the body 10. The other control conditions of forming the second transition layer 142 are similar to the control conditions of forming the first transition layer 141.

While certain embodiments of the present invention have been described and exemplified above, various other embodiments will be apparent to those skilled in the art from the foregoing disclosure. The present invention is, therefore, not limited to the particular embodiments described and exemplified but is capable of considerable variation and modification without departure from the scope of the appended claims.

What is claimed is:

1. An article, comprising:
a body comprised of steel,
an electroless nickel layer electroless-plated on the body, and
a diamond-like carbon layer formed on the electroless nickel layer.

2. The article as claimed in claim 1, the electroless nickel layer has a thickness in a range from 5 microns to 50 microns.

3. The article as claimed in claim 1, the diamond-like carbon layer has a thickness in a range from 1 nanometer to 2000 nanometers.

4. The article as claimed in claim 1, further comprising a transition layer sandwiched between the electroless nickel layer and the diamond-like carbon layer.

5. The article as claimed in claim 1, wherein the transition layer comprises a first transition layer formed on the electroless nickel layer, and a second transition layer sandwiched between the first transition layer and the diamond-like carbon layer, the first transition layer being comprised of a material selected from a group consisting of chromium, titanium, and chromium titanium, and the second transition layer being comprised of a material selected from a group consisting of chromium nitride, titanium nitride and chromium titanium nitride.

6. The article as claimed in claim 5, wherein the first transition layer has a thickness in a range from 1 nanometer to 30 nanometers, and the second transition layer has a thickness in a range from 1 nanometer to 50 nanometers.

7. A method for manufacturing an article as claimed in claim 1, comprising the steps of:
providing a body comprised of steel;
electroless plating an electroless nickel layer on the body; and
forming a diamond-like carbon layer on the electroless nickel layer.

8. The method as claimed in claim 7, further comprising a step of cleansing the body prior to electroless plating the electroless nickel layer on the body.

9. The method as claimed in claim 7, further comprising a step of electroplating a nickel layer on the body prior to electroless plating the electroless nickel layer on the body.

10. The method as claimed in claim 9, wherein the step of electroplating the nickel layer is performed for a time period in a range from 30 seconds to 60 seconds.

11. The method as claimed in claim 7, further comprising a step of heating the body with the electroless nickel layer thereon.

12. The method as claimed in claim 11, wherein the step of heating the body with the electroless nickel layer thereon is performed at a temperature in a range from 350 degrees Celsius to 450 degrees Celsius.

13. The method as claimed in claim 11, wherein the step of heating the body with the electroless nickel layer thereon is performed for a time period of about 1 hour.

14. The method as claimed in claim 7, further comprising a step of forming a transition layer on the electroless nickel layer prior to forming the diamond-like carbon layer.

15. The method as claimed in claim 14, wherein the transition layer and the diamond-like carbon layer are sequentially formed on the electroless nickel layer by sputtering deposition, and a sputtering gas flow rate for forming the transition layer and the diamond-like carbon layer is in a range from 1 to 100 standard cubic centimeters per minute.

16. The method as claimed in claim 14, wherein the transition layer and the diamond-like carbon layer are sequentially formed on the electroless nickel layer by sputtering deposition at a bias voltage in a range from −50 volts to 200 volts.

17. The method as claimed in claim 14, wherein the transition layer and the diamond-like carbon layer are sequentially formed on the electroless nickel layer by sputtering deposition at a pressure in a range from 1×10⁻⁵ pascals to 10×10⁻⁴ pascals.

18. The method as claimed in claim 14, wherein the transition layer and the diamond-like carbon layer are sequentially formed on the electroless nickel layer by sputtering deposition at a temperature in a range from 25 degrees Celsius to 150 degrees Celsius.
